(19) United States
(12) Patent Application Publication
(10) Pub. No.: US 2011/0053726 A1
(43) Pub. Date: Mar. 3, 2011

(54) Gear Reduction and Coupling Assembly

(75) Inventor: Robert William Thompson, Hampshire (GB)

(73) Assignee: QINETIQ LIMITED

(21) Appl. No.: 12/821,402

(22) Filed: Jun. 23, 2010

(30) Foreign Application Priority Data
Sep. 3, 2009 (GB) 0915305.7

(51) Int. Cl. F16H 37/02

(52) U.S. Cl. 475/207

(57) ABSTRACT

A gear reduction and coupling assembly, particularly for incorporation in a transverse drive arrangement for a skid steered vehicle, comprises a planetary gear mechanism having an input through the sun gear and an output through the planet carrier. A coupling member is coupled to the carrier through a crowned spline coupling and is coupled to a subsequent transmission member such as a shaft through a parallel splined coupling, the diameter of the crowned spline coupling being substantially greater than the diameter of the parallel splined coupling. In this way a degree of angular misalignment between the subsequent transmission member and the planet carrier can be accommodated while a similar torque transmitting capacity can be achieved for both of the couplings with the coupling member.

### FIELD OF THE INVENTION

The present invention relates to a gear reduction and coupling assembly. It will be described hereinafter more particularly in terms of its application within an overall drive configuration for a battle tank, bulldozer or other skid steered tracked or wheeled vehicle of the kind described in WO-02/083483 or WO-2006/021745, although it may be found more generally useful where a planetary gear reduction stage needs to transmit high torque to a shaft or other member and the arrangement needs to accommodate a certain angular misalignment between the two.

### BACKGROUND OF THE INVENTION

Any practical transmission mounting arrangement and vehicle structure will have certain inaccuracies, and corresponding angular misalignments between nominally coaxially coupled transmission components must therefore be accommodated. One way of achieving this in the case of splined couplings is to crown the splines on one of the components. That is to say the flanks of the teeth are modified as compared to the usual parallel form and are convex in the lengthwise direction so that when meshed with a set of parallel splines on the other component the assembly can rotate together with some angular misalignment without jamming. A disadvantageous consequence of such crowning, however, is that there is only a small contact area (near point contact) between each internal and external mating spline tooth, which reduces the maximum torque which can be transmitted through the coupling as compared to parallel-to-parallel spline sets which can spread the load over a larger contact area for the same coupling diameter. One way in which to carry higher torque through a crowned spline coupling, however, is to increase its diameter. Increasing diameter reduces the total shear load carried by the teeth and also increases the circumference of the coupling, thus accommodating more teeth and/or larger teeth. Torque capacity therefore nominally increases in proportion to diameter squared.

### SUMMARY OF THE INVENTION

With the foregoing in mind, in one aspect the present invention resides in a gear reduction and coupling assembly comprising: a planetary gear mechanism having an input through the sun gear and output through the planet carrier; and a coupling member coupled to said carrier through a crowned spline coupling of a first diameter; said coupling member also being adapted to be coupled to a subsequent transmission member through a splined coupling of a second diameter; said first diameter being substantially greater than said second diameter.

In this way angular misalignment between the subsequent transmission member (typically a shaft) and the planet carrier of the gear reduction assembly can be accommodated by virtue of the crowned splines in the larger diameter coupling between the coupling member and the planet carrier. Conventional parallel-to-parallel spline sets can therefore be used in the smaller diameter coupling between the coupling member and the subsequent member, and a similar torque transmitting capacity achieved for both of the couplings with the coupling member.

In principle the splines which are crowned in the coupling between the coupling member and the planet carrier can be either the external spline set or the internal spline set, and either component can be configured to carry the external set or the internal set. In a preferred embodiment, however, the crowned splines are an external set provided on the planet carrier which mate with internal parallel splines on the coupling member.

Similarly either of the coupling member or subsequent transmission member can be configured to carry the external or internal spline set in the smaller diameter coupling, although when for example it is desired to minimise the diameter of a shaft which constitutes the subsequent member then that component will carry the external splines.

The face width of the splines in the coupling between the planet carrier and coupling member is typically substantially less than the face width of the splines between the coupling member and subsequent transmission member.

The coupling member is preferably axially located with respect to the planet carrier though a spherical joint held in the carrier—or by any other form of joint which can both axially locate the coupling member and permit its articulation relative to the planet carrier occasioned by the misalignment between the subsequent transmission member and planet carrier—and through flexible means permitting limited axial displacement between the coupling member and planet carrier.

In another aspect the invention resides in a drive configuration for a skid steered vehicle comprising: a pair of propulsion motors coupled through respective transmissions to drive a respective drive member (such as a track drive sprocket in the case of a tracked vehicle or a wheel hub in the case of a wheeled vehicle) at a respective side of the vehicle; at least one steer motor coupled to a differential gear mechanism coupled between said propulsion motors to selectively impose a speed difference between said drive members; and a respective gear reduction and coupling assembly according to the first aspect of the invention within each said transmission; the sun gear of each said assembly being arranged to be driven from the respective said propulsion motor; and the coupling member in each said assembly being coupled to a respective transmission member leading towards the respective said drive member.

### BRIEF DESCRIPTION OF THE DRAWINGS

These and other features of the present invention will now be more particularly described, by way of example, with reference to the accompanying drawings, in which:

FIG. 1 is a diagrammatic illustration of a drive configuration for a skid steered vehicle in which the invention may be embodied;

FIG. 2 illustrates schematically a mechanism for the controlled differential of the configuration of FIG. 1;

FIG. 3 is an axial cross-section through a practical implementation of a gear reduction and coupling assembly according to the invention as embodied in the drive configuration of FIG. 1; and

FIG. 4 illustrates the typical form of a crowned spline.

### DETAILED DESCRIPTION OF THE PREFERRED EMBODIMENT

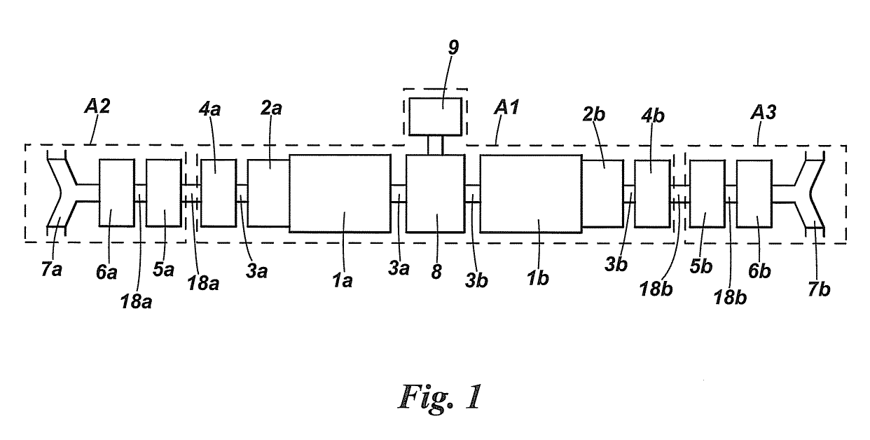

FIG. 1 illustrates diagrammatically one form of vehicular drive configuration with which gear reduction and coupling assemblies in accordance with the present invention may be found particularly useful, being a track drive arrangement for a skid steered vehicle according to WO-02/083483 or WO-2006/021745. In this Figure a transverse drive arrangement comprises two electric propulsion motors 1a and 1b with associated gear change units 2a and 2b turning drive shafts 3a and 3b respectively. Outbound of these units the transmission includes in each case a gear reduction stage 4a, 4b, a brake 5a, 5b and a final drive gear reduction 6a, 6b, leading to respective track drive sprockets 7a and 7b at opposite sides of the vehicle. Inboard the motors 1a, 1b are coupled through the shafts 3a, 3b to opposite sides of a controlled differential device 8 having an input from one or more electric steer motors 9.

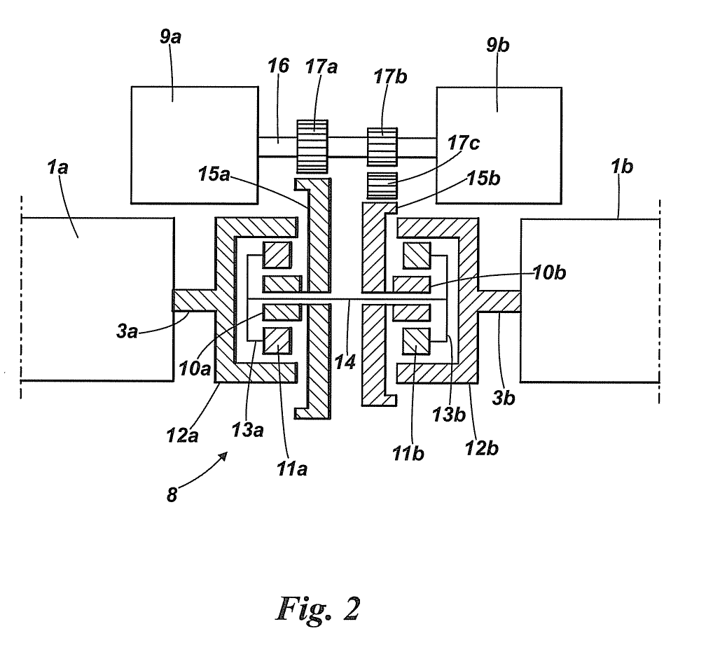

The mechanism of one suitable form of differential 8 is illustrated schematically in FIG. 2. It comprises an opposed pair of planetary gear sets each comprising a sun gear 10a, 10b, planet gears 11a, 11b and an annulus or ring gear 12, 12b, with the planet carriers 13a, 13b of each set interconnected by a cross shaft 14 passing through the sun gears. The annuli 12a, 12b are coupled to the respective adjacent drive shafts 3a, 3b and the sun gears 10a, 10b are fast with respective input gears 15a, 15b which can be driven when required in this case by a coupled pair of steer motors 9a, 9b. The steer motors are in this respect each coupled to a shaft 16 carrying a pinion 17a meshing with gear 15a, and a pinion 17b meshing through an idler gear 17c with gear 15b, so that the direction of rotation of the gear 15b in response to rotation of the shaft 16 is reversed as compared to the direction of rotation of the gear 15e.

During straight running of the vehicle the steer motors 9a, 9b are energised to hold the shaft 16 stationary, so the input gears 15a, 15b and sun gears 10a, 10b are likewise held stationary. Energising the propulsion motors 1a, 1b to drive the sprockets 7a, 7b in this condition also rotates the annuli 12a, 12b to cause the planet gears 11a, 11b to revolve about the sun gears 10a, 10b. Due to their connection by the shaft 14 the two planet carriers 13a, 13b must rotate at the same speed, also equalising the speeds of the two annuli 12a, 12b and the two connected shafts 3a, 3b and related transmission trains in this condition. The actual power distribution between the two transmissions will be determined by the torque required to drive the respective sprockets 7a, 7b with torque being transferred through the controlled differential 8 from one side to the other as required e.g. in respect to changing ground conditions.

To turn the vehicle in one sense while being propelled by the motors 1a, 1b as above the steer motors 9a, 9b are energised to rotate the shaft 16 in a corresponding sense, thus causing the input gears 15a, 15b and their respective sun gears 10a, 10b to rotate in mutually opposite senses. The effect, since the two planet carriers 13a, 13b must always turn together, is to increase the rate of rotation of the individual planet gears 11a, or 11b in that set for which the sun gear 10a or 10b is turning in the opposite sense to the respective annulus 12a or 12b, and to decrease the rate of rotation of the individual planet gears 11a or 11b in that set for which the sun gear 10a or 10b is turning in the same sense as the respective annulus 12a or 12b. This in turn causes the annuli 12a, 12b and respective connected transmissions to the sprockets 7a, 7b to run at different speeds thus turning the vehicle in the required sense, while power from the slower running transmission is mechanically regenerated to the faster running transmission through the controlled differential 8. To turn the vehicle in the opposite sense the steer motors 9a, 9b are energised to rotate the shaft 16 in the opposite sense and so forth, and it will be appreciated that for a given forward speed of the vehicle the turning radius in either sense will depend on the speed at which the steer motors are operated—the faster the steer motors the tighter the turn. In the limit, with zero forward speed the vehicle can be made to perform a neutral turn—i.e. “turning on the spot”—by driving the two transmissions in opposite directions through the differential 8.

In a functionally equivalent arrangement one of the sun gears 10a or 10b can be permanently locked in place and a single gear train used from the shaft 16 to turn the other sun gear as required.

In practice the propulsion motors 1a,1b, gear change units 2a,2b, gear reduction stages 4a,4b, controlled differential 8 and steer motor(s) 9 of FIG. 1 are integrated together in a first major assembly A1 centrally of the vehicle while the respective brakes 5a,5b, final drives 6a,6b and track drive sprockets 7a,7b are integrated together in separate assemblies A2 and A3 to each side of the vehicle linked to the central assembly through respective coupling shafts 18a and 18b. In a preferred embodiment the shafts 18a,18b need to be of relatively small diameter to pass through the brakes 5a,5b and into the final drives 6a, 6b—where they are preferably coupled in accordance with our copending United Kingdom patent application no 0915306.5. There is preferably also provision for withdrawing these coupling shafts from the central assembly after assembly so that the central assembly can be lifted out of the vehicle if required, for example for maintenance purposes.

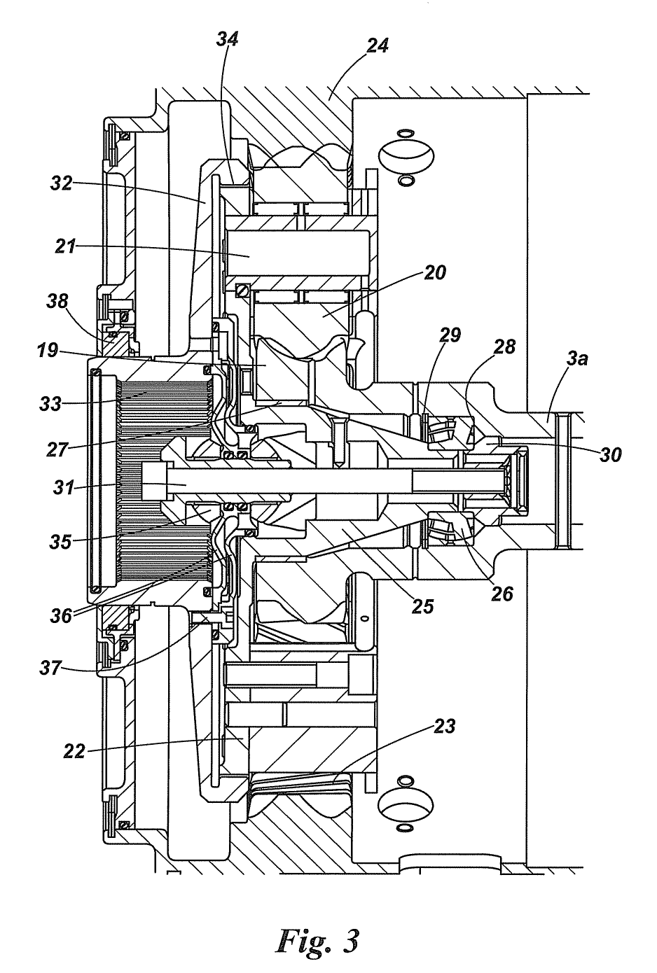

Turning to FIG. 3, this illustrates a practical implementation of the gear reduction stage 4a, and its relationship to the drive shaft 3a and to the coupling shaft 18a (itself not shown in FIG. 3) which leads to the brake 5a and final drive 6a in the left hand transmission as viewed in FIG. 1. The corresponding components in the right hand transmission are identical in mirror image.

The illustrated gear reduction stage comprises a planetary gear set of which the sun gear 19 is formed on the end of the drive shaft 3a. The latter is itself driven by the rotor of the propulsion motor 1a through the gear change unit 2a which is preferably in accordance with WO-05/054712. The sun gear 19 meshes with a set of helically cut planet gears 20 borne on respective pins 21 in a planet carrier 22 and the planet gears also mesh with a fixed annulus or ring gear 23 formed on the inside surface of the casing 24 of this part of the transmission. As the shaft 3a and sun gear 19 rotate the planet carrier 22 is also caused to turn, but at a slower rate, by virtue of the revolution of the planet gears 20 around the ring gear 23, and it provides the output of the gear reduction stage. The assembly of the planet carrier 22 and planet gears 20 “floats” inside the ring gear 23 and the drive shaft 3a “floats” with it. In this respect a central spigot 25 from the planet carrier is received in the end of the drive shaft 3a and borne rotationally relative to that shaft by a spherical roller bearing 26 and a needle roller bearing 27, the bearing 26 also serving to locate the carrier 22 axially with respect to the shaft 3a. In this respect the bearing 26 is itself axially located between a shoulder 28 on the shaft 3a and a snap ring 29, and is also clamped between the spigot 25 and a threaded retainer 30 by means of a bolt 31. Although not readily apparent in FIG. 3 there is a small radial clearance between the retainer 30 and the internal surface of the shaft 3a.

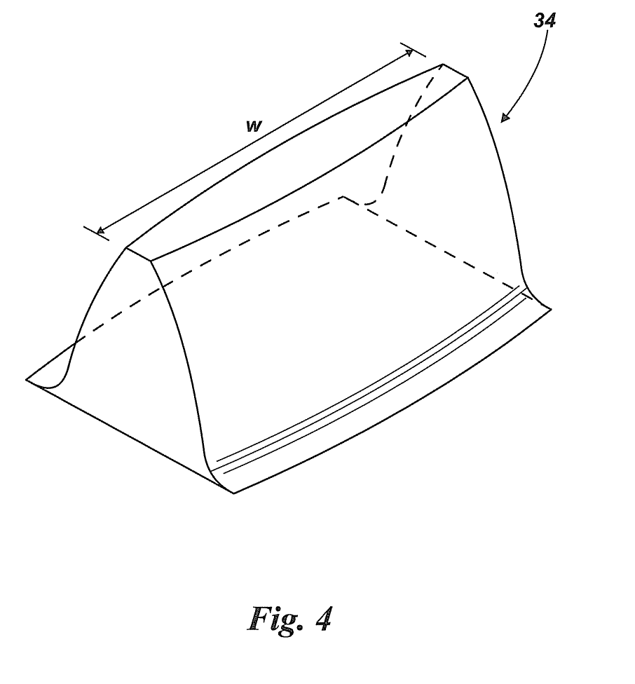

The rotation of the planet carrier 22 is transmitted to the subsequent coupling shaft 18a through a coupling member 32 having a set of internal parallel splines 33 to mate with external parallel splines on that shaft. In this respect it is anticipated that the coupling shaft may be angularly misaligned from the planet carrier 22 by up to 1°, and by virtue of the shaft's parallel-to-parallel splined connection to the coupling member 32 that member may be equally misaligned with respect to the planet carrier. To accommodate such misalignment the flange of the carrier 22 is formed on its outside perimeter with a set of external crowned splines 34. The typical form of such a spline is shown in FIG. 4, the flanks being curved to present a convex profile in the lengthwise direction. These splines mate with a set of internal parallel splines provided on the coupling member 32 at a substantially greater radius than the splines 33. It will be observed that the face width of the splines in the coupling between the planet carrier 22 and the coupling member 32, i.e. the dimension w in FIG. 4, is substantially less than the face width of the splines (e.g. 33) in the coupling between the coupling shaft and the coupling member 32, this being necessary due to the crowned form of the splines 34 and the need to prevent the splines jamming as the misaligned components rotate together. Despite the crowning of the splines 34, however, and the consequently small contact area between each mating spline tooth in the coupling between the planet carrier 22 and the coupling member 32, the torque transmitting capacity of that coupling can match that of the coupling between the parallel-to-parallel splines of the coupling shaft and the member 32 by virtue of its substantially greater diameter.

The coupling member 32 is located axially in the assembly by a ball joint (spherical joint) 35 held in the planet carrier spigot 25 by the bolt 31, and from which a pair of discs 36 radiate and are fixed to the member 32 by a series of screws such as indicated at 37. The ball joint 35 permits the articulation of the coupling member 32 relative to the planet carrier 22 occasioned by the anticipated degree of misalignment of the coupling shaft. The discs 36 are also of such flexibility as to permit a small degree of axial movement of the coupling member 32 relative to the planet carrier 22. This is a protection mechanism for the bearing 26 in the event that a high axial load is applied through the coupling shaft to the member 32, for example due to flexure of the vehicle chassis, and particularly under high torque operation when the friction due to loading on the splines between the coupling shaft 18a and member 32 will preclude any axial play between those components.

An oil seal assembly 38 around the hub of the coupling member 32 is also mounted in the casing 24 such as to accommodate the articulation of the coupling member.

1. A gear reduction and coupling assembly comprising: a planetary gear mechanism having an input through the sun gear and an output through the planet carrier; and a coupling member coupled to said carrier through a crowned spline coupling of a first diameter; said coupling member also being adapted to be coupled to a subsequent transmission member through a splined coupling of a second diameter; said first diameter being substantially greater than said second diameter.

2. An assembly according to claim 1 wherein said carrier has a set of external crowned splines and said coupling member has a set of internal parallel splines for coupling with said external splines of said carrier.

3. An assembly according to claim 1 comprising a said subsequent transmission member in the form of a shaft with a set of external parallel splines for coupling with a set of internal parallel splines on said coupling member.

4. An assembly according to claim 1 wherein the face width of the splines in the coupling between said carrier and coupling member is substantially less than the face width of the splines in the coupling between said coupling member and subsequent transmission member.

5. An assembly according to claim 1 wherein said coupling member is axially located with respect to said carrier through a spherical joint held in said carrier.

6. An assembly according to claim 1 wherein said coupling member is axially located with respect to said carrier through flexible means permitting limited axial displacement between said coupling member and carrier.

7. A drive configuration for a skid steered vehicle comprising: a pair of propulsion motors coupled through respective transmissions to drive a respective drive member at a respective side of the vehicle; at least one steer motor coupled to a differential gear mechanism coupled between said propulsion motors to selectively impose a speed difference between said drive members; and a respective gear reduction and coupling assembly according to claim 1 within each said transmission; the sun gear of each said assembly being arranged to be driven from the respective said propulsion motor; and the coupling member in each said assembly being coupled to a respective transmission member leading towards the respective said drive member.

8. A drive configuration according to claim 7 wherein the planet carrier of each said assembly has a set of external crowned splines and the coupling member of each said assembly has a set of internal parallel splines for coupling with said external splines of the respective said carrier.

9. A drive configuration according to claim 7 comprising respective said subsequent transmission members each in the form of a shaft with a set of external parallel splines for coupling with a set of internal parallel splines on the respective said coupling member.

10. A drive configuration according to claim 7 wherein the face width of the splines in the coupling between the planet carrier and coupling member of each said assembly is substantially less than the face width of the splines in the coupling between the respective said coupling member and subsequent transmission member.

11. A drive configuration according to claim 7 wherein the coupling member of each said assembly is axially located with respect to the respective planet carrier through a spherical joint held in the respective said carrier.

12. A drive configuration according to claim 7 wherein the coupling member of each said assembly is axially located with respect to the respective planet carrier through flexible means permitting limited axial displacement between the respective said coupling member and carrier.

13. A skid steered vehicle equipped with a drive configuration according to claim 7.

14. A vehicle according to claim 13 wherein the planet carrier of each said assembly has a set of external crowned splines and the coupling member of each said assembly has a set of internal parallel splines for coupling with said external splines of the respective said carrier.

15. A vehicle according to claim 13 comprising respective said subsequent transmission members each in the form of a shaft with a set of external parallel splines for coupling with a set of internal parallel splines on the respective said coupling member.

16. A vehicle according to claim 13 wherein the face width of the splines in the coupling between the planet carrier and coupling member of each said assembly is substantially less than the face width of the splines in the coupling between the respective said coupling member and subsequent transmission member.

17. A vehicle according to claim 13 wherein the coupling member of each said assembly is axially located with respect to the respective planet carrier through a spherical joint held in the respective said carrier.

18. A vehicle according to claim 13 wherein the coupling member of each said assembly is axially located with respect to the respective planet carrier through flexible means permitting limited axial displacement between the respective said coupling member and carrier.
